(19) United States
(12) Patent Application Publication
(10) Pub. No.: US 2012/0065825 A1
(43) Pub. Date: Mar. 15, 2012

(54) Electric Front Wheel Drive System for Motorcycle

(76) Inventor: Reginald Leonard Nicoson, Windsor, CO (US)

(21) Appl. No.: 13/269,125

(22) Filed: Oct. 7, 2011

Related U.S. Application Data
(63) Continuation-in-part of application No. 12/539,756, filed on Aug. 12, 2009.

(51) Int. Cl. B60L 15/20; B60L 11/18; B62K 11/00

(52) U.S. Cl. 701/22; 180/220; 180/197

(57) ABSTRACT

A two-wheel drive motorcycle having a motor-generator driving the front wheel, an embodiment of the present invention, in addition to and independent of a conventional rear wheel drive train. The front wheel drive disclosed herein may be adapted to a conventional motorcycle front wheel and telescoping (or shock-absorbing) front fork suspension systems. The front wheel drive of the two-wheel drive motorcycle may be applied to a number of different types of motorcycles including motocross, enduro, dual-sport and touring motorcycles.

### CROSS REFERENCE TO RELATED APPLICATIONS

This application is a continuation in part of application Ser. No. 12/539,756 filed Aug. 12, 2009.

### BACKGROUND OF THE INVENTION

The present invention relates to motorcycles, and more particularly, is related to an electric front wheel drive system for a motorcycle.

It is known and accepted that a motorcycle with a front wheel drive system, which supplements the conventional rear wheel drive, would have improved traction, thus better acceleration and handling performance on any surface condition.

Several patents on front wheel drive or ail-Wheel drive systems for motorcycles exist. U.S. Pat. No. 7,487,854 shows a two-wheel drive motorcycle having a drive train that supplies power to the front wheel using, a series of rigid shafts or other internalized drive gears. U.S. Pat. No. 5,894,903 shows an all wheel drive motorcycle using a hydraulic pump and hydraulic motor. In the case of Tanaka (JP 405016872), the electric front wheel drive system is an integral part of the rear wheel drive system. The front and rear wheel drives share the same sensor inputs and the same controller. The controller simultaneously acts to increase or decrease the power to the front and rear wheel drive systems in response to changes in vehicle speed and throttle position. The Tanaka design uses both front and rear wheel speed to calculate a vehicle speed. The Tanaka design uses vehicle speed and wheel speed to calculate a speed difference which is used in conjunction with a speed versus time data curve to determine the front wheel demand. The Tanaka design is an integrated, full time all-wheel-drive system where the front wheel electric motor can solely power the vehicle if demanded. In the case of Kinzel (U.S. Pat. No. 3,884,317), the motor only acts as a motor and requires a separate generator mechanically linked to the rear drive system. Thus, the front wheel drive system described by Kinzel is an integral part of the rear wheel drive system, rendered non-functional without it. Other patents describe control methods for motorcycle stability. Hasegawa (U.S. Pat. No. 7,124,852) claims to use two axis accelerometers to detect forward and side to side motion. The acceleration signals are used solely to decrease the engine demand to prevent the rider from losing control of the motorcycle. Giorgio (WO 2007/096798 uses multiple axis accelerometers to detect the inclination angle of the vehicle in respect to the horizontal plane. The inclination angle is used solely to stop the engine ignition to prevent accidental turn-over, more commonly known as a “wheelie”, Carney (U.S. Pat. No. 6,260,649) shows how two or more motor-generators can be used to power a vehicle and recharge a battery while braking, moving downhill or the application of mechanical energy like pedaling a bike

To the applicant's knowledge there is not an independent electric front wheel drive system for motorcycles. That is, a system that drives the front wheel with an electric motor-generator and controller independent of the rear wheel drive system. No prior act was found that describes a front wheel drive system that is designed to assist the rear wheel drive train on demand, but full time operation.

### DESCRIPTION OF THE DRAWINGS

FIG. 1 is a schematic illustrating a motorcycle that an embodiment of the present invention may operate.

FIG. 2 is a block diagram illustrating the components that comprise an electric front wheel drive system.

FIG. 3 is a control block diagram illustrating a control strategy of an electric front wheel drive system.

FIG. 4 is a sectional drawing view illustrating the motor-generator.

FIG. 5 is an isometric drawing illustrating the motor-generator shaft.

### DETAILED DESCRIPTION OF THE INVENTION

The following detailed description of preferred embodiments refers to the accompanying drawings, which illustrate specific embodiments of the invention. Other embodiments having different structures and operations do not depart from the scope of the present invention.

The present invention may be applied to motorcycles used in a wide variety of applications including, but not limiting of, motocross, enduro, dual-sport, touring, and the like. An embodiment of the present invention takes the form of an application, product and or method that may incorporate advanced controls, sensors, batteries, mechanical structures and a light-weight electric motor-generator.

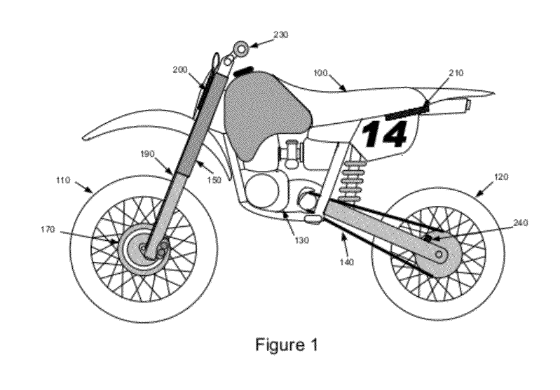

Referring to FIG. 1, there is illustrated a motorcycle 100, which includes a front wheel 110, and a rear wheel 120. The rear wheel 120 is driven by an internal combustion engine 130 or other means through a drive chain 140. The front wheel 110 is mounted to the telescoping fork 150 suspension.

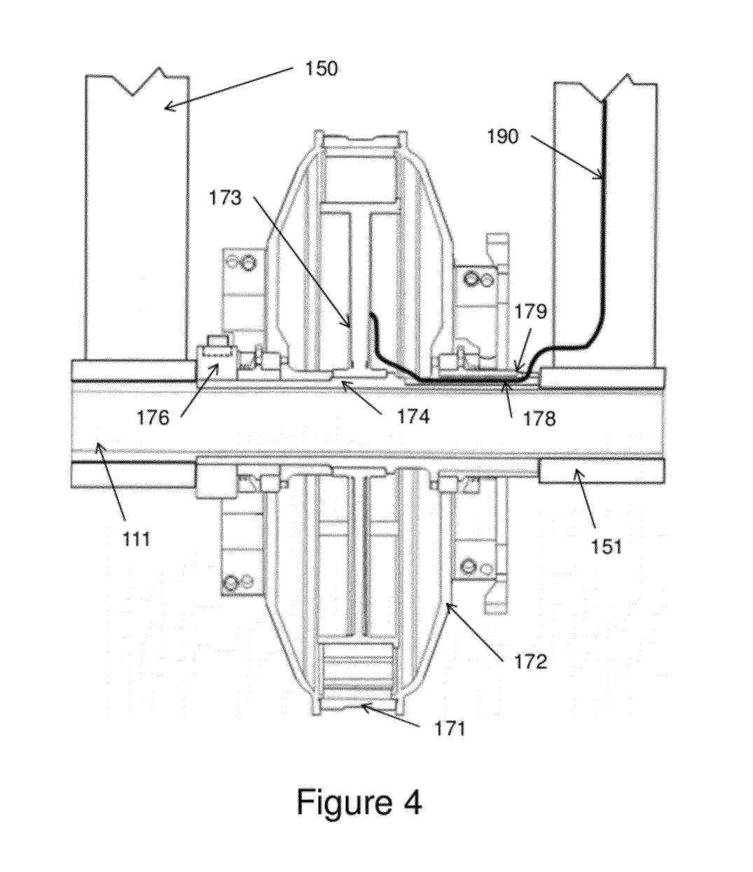

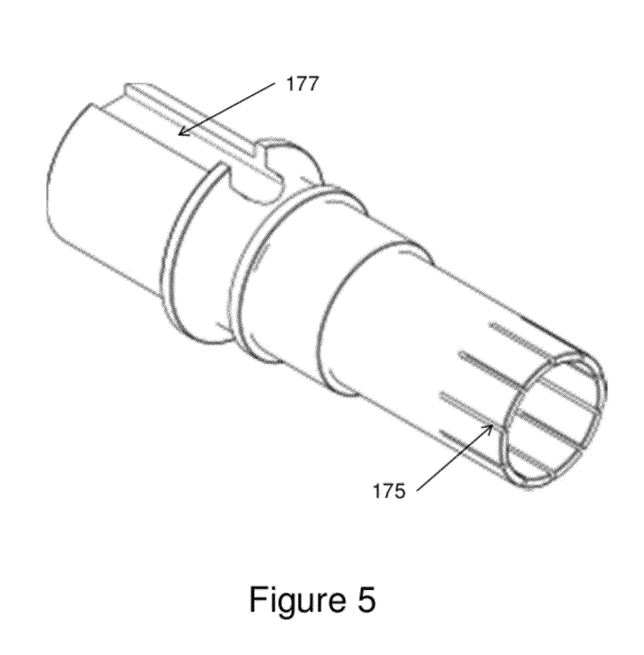

The front wheel 110 comprises an electric motor-generator included in the embodiment of this invention integrated into the hub, hereafter referred to as motor-generator 170. The motor-generator 170 is a high efficiency, light-weight brushless type motor, shown in detail in FIG. 4. The motor-generator rotor 171, or rotating part, is connected to the wheel hub 172, which is connected to the wheel rim by spokes or other means. The motor-generator stator 173, or stationary part, has a rigid connection to the motor-generator shaft 174. The motor-generator shaft 174, an embodiment of this invention shown in detail in FIG. 5, is a hollow shaft that has a plurality of narrow slits 175 at one end. The motorcycle's front wheel axle shaft 111 is inserted through the center of the motor-generator's shaft 174. A shaft lock collar 176 positioned at the end of the motor-generator shaft with the narrow slits clamps the motor-generator shaft 174 to the front wheel axle shaft 111. The front wheel axle shaft 111 is typically clamped in place to prevent rotation with clam-shell type axle clamps 151 built into the lower end of the telescoping forks 150. The front wheel axle 111 and telescoping fork 150 clamping mechanism are universally applied to motorcycles and is not an embodiment of this invention. The motor-generator shaft 174, shaft lock collar 176, front wheel axle 111, and front wheel axle clamp 151 mechanical structures prevent the motor-generator stator 173 from rotating about the front wheel axle 111 due to torque created by the motor-generator while in operation.

The motor-generator cable 190 is routed from the motor-generator stator 173 through a wire channel 178 created by a longitudinal groove 177 cut into the motor-generator shaft 174 and a replaceable wheel bearing bushing 179. The motor-generator cable has a rigid protective sheath that guides it up the telescoping fork 150 to the controller. The brake disk will mount to the motor-generator. It should be clarified that the brake caliper and front wheel mounting or supporting structures may be integrated or arranged in various ways. The operation of the motorcycle's conventional front fork suspension and brakes is not affected by the electric front wheel drive system.

The controller 200 included in the embodiment of this invention is typically mounted high on the telescoping forks 150 near the motorcycle handle bars.

The energy used by the front wheel drive system is supplied from an energy storage device comprised of a battery or hybrid battery, hereafter referred to as battery 210. The battery 210 is typically mounted near the rear of the motorcycle.

Driver front brake controls, and control switch 230 comprise some of the inputs to the controller. These controls are typically mounted on the handle bars. The control switch and front brake feedback sensor in the embodiment of this invention are independent of the rear wheel drive system.

The rear wheel speed sensor 240 is typically mounted on or near the rear wheel drive train. A rear wheel speed sensor is not universally applied to motorcycles so the rear wheel speed sensor in the embodiment of this invention is independent of any sensor used for the rear wheel drive train.

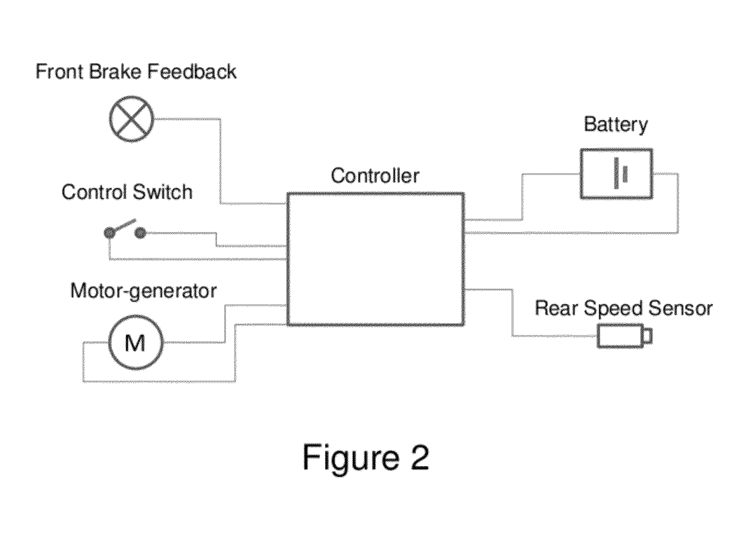

Referring now to FIG. 2, the block diagram illustrates the electrical architecture, a possible implementation of an electric front wheel drive system. In the present invention the controller 200 may receive a plurality of signals not limited to motor-generator position and speed, rear wheel speed, brake demand (position and or pressure), battery volts/amps, control switch, or the like. The controller is a digital control system, with hardware and software aspects, which control the motor-generator.

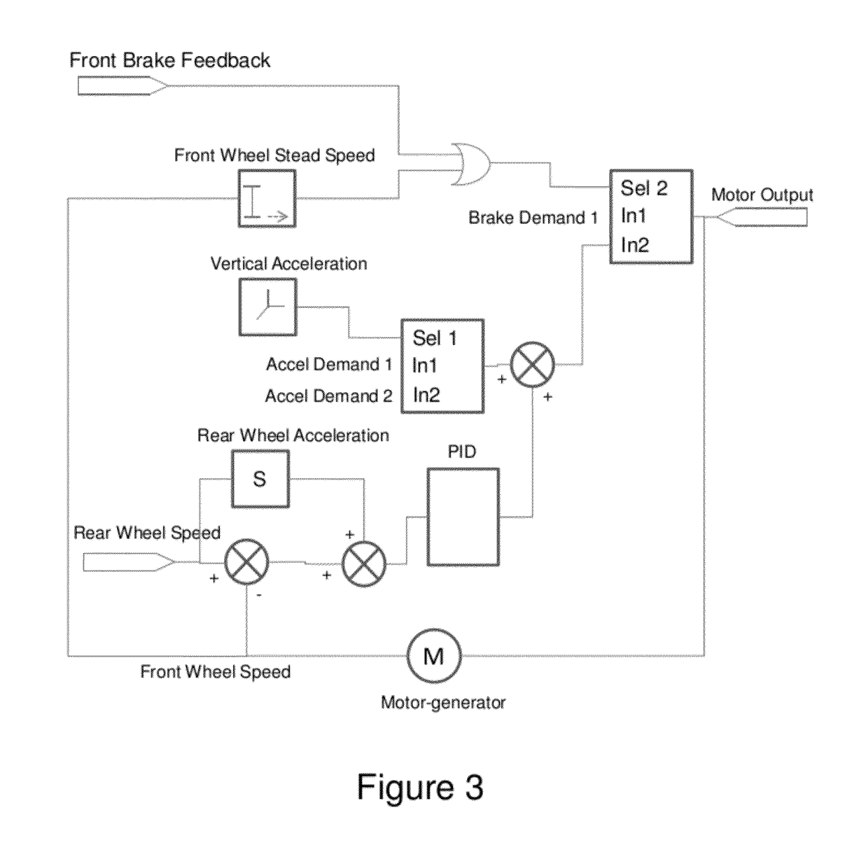

Now referring to FIG. 3, the controller constantly monitors the front wheel's motor-generator speed, the rear wheel speed, the front brake system feedback, multiple axis accelerometers, and the driver input control switches and adjusts the motor's output to reduce rear wheel slip, assist braking, recharge the battery, and reduce the front wheel's rotational inertia effect on the motorcycle's stability. The control algorithms that comprise the embodiment of this invention take the form of software, firmware and hardware inside the controller. For the purpose of this invention, rear wheel slip is the difference between rear wheel speed and front wheel speed. Rear wheel acceleration is the derivative math function of rear wheel speed. If the calculated slip increases, or the rear wheel is accelerating the controller will increase the output of the motor-generator proportionally. The reverse is true for a decrease in slip or rear wheel acceleration. When rotational speed of the rear wheel is within 1%-2% of the front wheel no power is delivered to the motor-generator. The controller uses horizontal and vertical acceleration signals from a multiple axis accelerometer to detect when the motorcycle is traveling uphill. Uphill travel is detected when the ratio of the horizontal and vertical acceleration signals is greater than a threshold value, an indication of a large inclination angle with respect to the horizontal plane. If uphill travel is detected the controller will increase the output of the motor-generator. The rotational inertia from accelerating a motorcycle's front wheel while airborne can he dangerous for an unfamiliar rider. This invention reduces or eliminates the effect of rotational inertia by using an accelerometer to detect when the motorcycle has left the ground (large vertical acceleration), then maintaining a steady power level to the front wheel motor-generator. The controller uses the vertical acceleration signal from a multiple axis accelerometer to calculates the vertical acceleration in respect to the ground and compares it to a threshold value. If the vertical acceleration is greater than the said threshold value, it is understood that the motorcycle's wheels are not in contact with the ground.

The electric front wheel drive system is designed to have an unlimited range under most driving conditions, for the battery can be recharged in many ways, including but not limited to, a plug-in wall charger, re-generative braking, or parasitic charging. The plug-in wall charger is just for topping off the battery before leaving home. Again referring to FIG. 3, when the driver applies the front brake, the front brake feedback sensor in the form of a pressure switch or position switch commands the controller to use the motor-generator as a generator to slow the motorcycle, plus recharge the battery. Re-generative braking can provide large charging currents anytime the motorcycle's from wheel brakes are applied. The amount of charge current will be proportional to the braking demand. Re-generative braking is well known and is not an embodiment of this invention. A parasitic charging an embodiment of this invention is provided to charge the front wheel drive system battery if the battery's charge level is near the lower operating limit. The front wheel speed is compared to a minimum speed threshold value and the lagged value of the front wheel speed plus/minus a deadband value. If the front wheel speed is greater than the threshold value and within the lagged speed value with deadband, the motorcycle is determined to be at a high rate and steady speed. When the controller detects this condition it uses the motor-generator as a generator to recharge the battery. The amount of charge current will be proportional to the front wheel speed but is generally less than the re-generative braking charge current.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, operations, elements, and/or components, but do not preclude the presence or addition of one or more other features, operations, elements, components, and/or groups thereof.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. An independent electric powered front wheel drive system for a motorcycle provided to assist a rear wheel drive train, comprising:
a motor-generator integrated into the front wheel;
cable from said motor-generator connected to the motor-generator controller;
a controller comprising hardware and software which requires no inputs to or feedback from a rear wheel drive train system;
a rechargeable battery.

2. The front wheel drive system for a motorcycle defined in claim 1, wherein said motor-generator uses a shaft lock collar to secure the motor-generator shaft to the front wheel axle shaft, preventing rotation of the motor-generator stator during operation.

3. The front wheel drive system for a motorcycle defined in claim 1, wherein said motor-generator's cable is routed through a channel formed by a groove in the motor-generator shaft and a replaceable front wheel bearing bushing.

4. The front wheel drive system for a motorcycle defined in claim 1, wherein said controller regulates the power to the motor-generator based on rear wheel slip, the difference between the front wheel speed and the rear wheel speed.

5. The front wheel drive system for a motorcycle defined in claim 1, wherein said controller regulates the power to the motor-generator based on the controller's calculation of a large inclination angle to the horizontal plane, an indication that the motorcycle is traveling uphill.

6. The front wheel drive system for a motorcycle defined in claim 1, wherein said controller maintains the power to the motor-generator, at the level prior to detection, based on the controller's calculation of a rapid increase in vertical acceleration indicating the motorcycle's wheels are not in contact with the ground.

7. The front wheel drive system for a motorcycle defined in claim 1, wherein said controller can command the motor-generator to re-charge the battery when the vehicle is traveling at a constant and high rate of speed.
